(19) United States
(12) Patent Application Publication
(10) Pub. No.: US 2012/0314038 A1
(43) Pub. Date: Dec. 13, 2012

(54) STEREOSCOPIC IMAGE OBTAINING APPARATUS

(75) Inventors: Kazuaki Murayama, Hachioji-shi (JP); Hisashi Goto, Suginami-ku (JP); Yuki Tokuhashi, Hachioji-shi (JP); Kazuya Yamanaka, Hachioji-shi (JP)

(73) Assignee: OLYMPUS CORPORATION, Tokyo (JP)

(21) Appl. No.: 13/408,321

(22) Filed: Feb. 29, 2012

(30) Foreign Application Priority Data
Jun. 9, 2011 (JP) 2011-129299

(51) Int. Cl. H04N 13/02

(52) U.S. Cl. 348/49; 348/E13.074

(57) ABSTRACT

A stereoscopic image obtaining apparatus has an optical system through which at least two parallax images are obtained, a first image creating unit that creates a first stereoscopic image from a single 2D image, a second image creating unit that creates a second stereoscopic image from the at least two parallax images; and a stereoscopic image selection unit that makes a selection between the first image creating unit and the second image creating unit. The stereoscopic image selection unit makes a selection in such a way that objects for which the first image generation unit is selected are more distant than objects for which the second image generation unit is selected.

### CROSS-REFERENCE TO RELATED APPLICATION

The present application is based upon and claims the benefit of priority from the prior Japanese Patent Application No. 2011-129299 filed on Jun. 9, 2011; the entire contents of which are incorporated herein by reference.

### BACKGROUND OF THE INVENTION

1. Field of the Invention

The present invention relates to a stereoscopic image obtaining apparatus.

2. Description of the Related Art

As a method of creating a 3D image (three-dimensional image), there is a 2D-to-3D conversion technique in which depth information is extrapolated from a 2D image (two-dimensional image) and a 3D image is created by image processing. In this technique, at least two parallax images are created from a 2D image based on information such as colors and edges of objects, blur, and contrast so that they can be viewed as a 3D image.

Japanese Patent Application Laid-Open 2009-211561, Japanese Patent Application Laid-Open No. 2010-171608, and Japanese Patent Publication No. 4214976 disclose apparatuses utilizing the above-mentioned conversion technique.

The depth data generation apparatus disclosed in Japanese Patent Application Laid-Open 2009-211561 separates image into a background image and an object image (i.e. the image of the subject), then creates depth value data, and outputs depth data.

The image processing apparatus disclosed in Japanese Patent Application Laid-Open No. 2010-171608 shifts a two-dimensional image horizontally to create images for right and left eyes, thereby displaying the two-dimensional image in a stereoscopic manner.

The pseudo stereoscopic image creating apparatus disclosed in Japanese Patent Publication No. 4214976 creates extrapolated data by analyzing the shooting scene to create a pseudo stereoscopic image.

The depth data generating apparatus disclosed in Japanese Patent Application Laid-Open No. 2009-211561 creates a stereoscopic image from a two-dimensional image by extracting contours in the images.

### SUMMARY OF THE INVENTION

A stereoscopic image obtaining apparatus according to the present invention has an optical system through which at least two parallax images are obtained, a first image creating unit that creates a first stereoscopic image from a single 2D image, a second image creating unit that creates a second stereoscopic image from the at least two parallax images; and a stereoscopic image selection unit that makes a selection between the first image creating unit and the second image creating unit. The stereoscopic image selection unit makes a selection in such a way that objects for which the first image generation unit is selected are more distant than objects for which the second image generation unit is selected.

### BRIEF DESCRIPTION OF THE DRAWINGS

FIG. 1 is a block diagram of a digital camera according to an embodiment of the present invention;

FIG. 2 is a schematic diagram illustrating the principle of the pupil splitting image picking-up;

FIG. 3A is a schematic diagram for the left image in FIG. 2;

FIG. 3B is a schematic diagram for the right image in FIG. 2;

FIG. 4 is a flow chart of the process of creating a stereoscopic image using the digital camera according to the embodiment of the present invention;

FIGS. 5A, 5B, and 5C schematically illustrate the process of creating a stereoscopic image of a subject at a near distance;

FIGS. 6A, 6B, 6C, and 6D schematically illustrate the process of creating a stereoscopic image of a subject at a far distance;

FIGS. 7A and 7B schematically illustrate the process of creating a stereoscopic image in a case where there are both a near figure and a far landscape.

### DETAILED DESCRIPTION OF THE INVENTION

In the following, an embodiment of the stereoscopic image obtaining apparatus according to the present invention will be described in detail with reference to the drawings. It should be understood that the present invention is not limited by the embodiment.

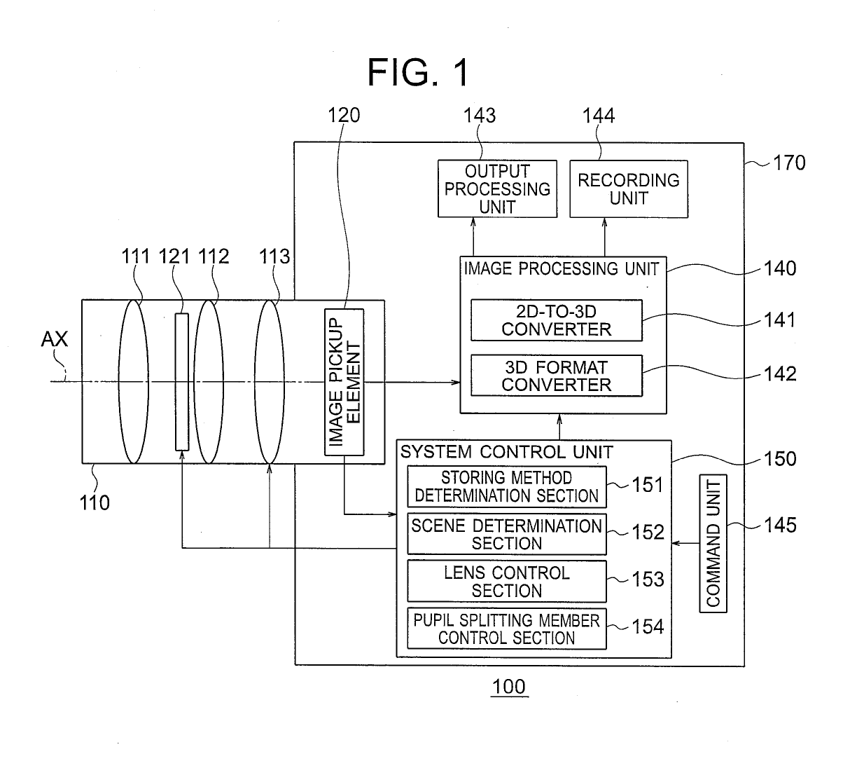

FIG. 1 is a block diagram of a digital camera 100 according to an embodiment of the present invention.

The digital camera 100, which constitutes a stereoscopic image obtaining apparatus, has a lens module 110 and a camera body 170 on which the lens module 110 can be detachably attached.

The lens module 110 has an optical system that can create at least two parallax images. The optical system includes a plurality of lenses (focus lenses) 111, 112, 113, a pupil splitting member 121, and an image pickup element 120.

The image pickup element 120 photo-electrically converts an image of an object formed on an image pickup surface to generate an electrical image signal.

The pupil splitting member 121 is disposed between the first lens 111 and the second lens 112. The pupil splitting member 121 splits the pupil of the light incident on the lens module 110 to form two parallax images on the image pickup surface of the image pickup element 120.

The pupil splitting member 121 may be disposed at a position outside the space between the first lens 111 and the second lens 112, if necessary, to fit the specifications of the digital camera 100. The pupil splitting member 121 may be adapted to form three or more parallax images.

The camera body 170 has an image processing unit 140, an output processing unit 143, a recording unit 144, a command unit 145, and a system control unit 150.

The image processing unit 140 includes a 2D-to-3D converter 141 and a 3D format converter 142.

The system control unit 150 includes a storing method determination section 151, a scene determination section 152, a lens control section 153, and a pupil splitting member control section 154.

The 2D-to-3D converter 141 serves as the first image creating unit to create a first stereoscopic image from a single 2D image.

The 3D format converter 142 serves as the second image creating unit to create a second stereoscopic image from at least two parallax images.

When the 3D mode is selected by the command unit 145, the 3D format converter 142 is set to the 3D mode by the system control unit 150. The 3D format converter 142 performs a 3D format conversion according to the set mode. Examples of the 3D mode conversion include SIDE-BY-SIDE, LINE-BY-LINE, ABOVE-BELOW, and CHECKERBOARD.

The output processing unit 143 outputs an image processed by the image processing unit 140 for display (including an image after 3D format conversion) to an external display apparatus such as a television set. In addition, the output processing unit 143 also outputs an image to a display device provided for displaying the operation menu of the digital camera 100 etc.

The recording unit 144 stores, in a nonvolatile manner, image data processed by the image processing section 140 for recording. The recording unit 144 may be, for example, a removable memory, such as a memory card, that can be taken out from the digital camera 100. Therefore, the recording unit 144 may not necessarily be a component belonging to the digital camera 100.

The command unit 145 is a user interface used to make operational entries to the digital camera 100. The command unit 145 includes a power button for turning on/off the power, an image taking button for starting image taking, an image taking mode setting button for setting the 3D mode etc, and other various setting buttons.

The scene determination section 152 serves as the shooting scene determination unit to estimate the distance to the subject based on the positions of the first lens 111, the second lens 112, and the third lens 113 in the lens module 110 to make a determination on the shooting scene.

The storing method determination section 151 determines the storing method based on the shooting scene determined by the scene determination section 152. The image picked up by the image pickup element 120 is stored according to the result of this determination. The storing method determination section 151 serves as the stereoscopic image selection unit to make selection between the first image generation unit and the second image generation unit. This selection is made in such a way that objects for which the first image generation unit is selected are more distant than objects for which the second image generation unit is selected.

The lens control section 153 outputs control signals for driving the first lens 111, the second lens 112, and the third lens 113 respectively to a lens driving unit (not shown) in accordance with a command signal from the system control unit 150.

The pupil splitting member control section 154 shifts the pupil splitting member 121 in a direction along the optical axis AX of the first lens 111, the second lens 112, and the third lens 113 in accordance with a command signal from the system control unit 150.

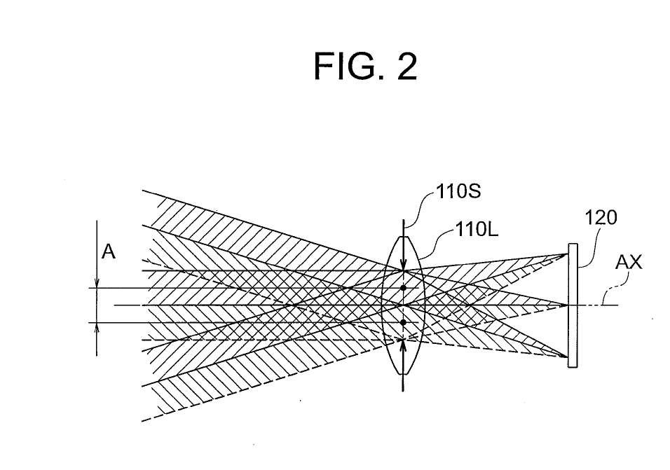

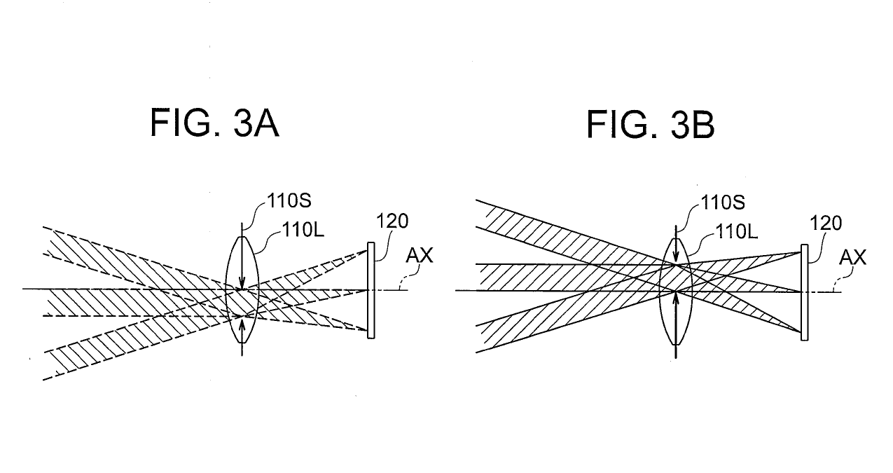

FIG. 2 is a schematic diagram illustrating the principle of the pupil splitting image picking-up. FIG. 3A is a schematic diagram for the left image in FIG. 2, and FIG. 3B is a schematic diagram for the right image in FIG. 2.

In FIGS. 2, 3A, and 3B, the lens 110L (having an optical axis AX) for creating two parallax images is split by the aperture stop 1105 into left and right portions. Light having passed through the aperture areas split by the aperture stop 1105 is imaged on the image pickup element 120 separately. The two images thus formed have a certain amount of parallax A determined by the aperture of the aperture stop 110S.

The thus picked-up two images displayed on a 3D television set allow stereoscopic viewing.

The method of pupil splitting image picking-up is not limited to that described above. Alternatively, for example, the transmittance of the left and right portions of the aperture may be changed using a liquid crystal shutter. The structure and the arrangement of the lenses and the pupil splitting member in the optical system are not limited to those described above, so long as at least two parallax images can be obtained.

The pupil splitting member 121 in FIG. 1 corresponds to the aperture stop 110S in FIGS. 2, 3A, and 3B, and the second lens 112 and the third lens 113 in FIG. 1 correspond to the lens 110L in FIGS. 2, 3A, and 3B. Therefore, light incident on the lens module 110 is split by the pupil splitting member with respect to the horizontal direction of the object, and two parallax images are formed on the image pickup element 120. The parallax images have a certain amount of parallax determined by the specifications of the pupil splitting member 121. The 3D format converter 142 generates a stereoscopic image (second stereoscopic image) using two picked-up images and then applies 3D format conversion to it. The image after the 3D format conversion is output by the output processing unit 143 to an external display apparatus to allow stereoscopic viewing on the external display apparatus.

Alternatively, a single 2D image may be formed on the image pickup element 120 without splitting the pupil by the pupil splitting member 121, and a stereoscopic image (first stereoscopic image) may be created in the 2D-to-3D converter 141 from the single 2D image thus obtained.

Whether the pupil spitting is to be performed or not is determined by the storing method determination section 151 based on the result of determination of the shooting scene by the scene determination section 152.

The 2D-to-3D converter 141 can generate a stereoscopic image also from parallax images obtained by splitting pupil.

When a 3D image created by the digital camera 100 is viewed on an external display apparatus such as a 3D television set or the like, it is preferred that the amount of parallax A or the amount of offset of the optical axes of two parallax images obtained through the lens module 110 be in the range of 1/100 to ⅕ of the distance between human eyes, as has been found by experiments. If this condition is met, a stereoscopic image of a subject at near distance can be obtained. The distance between human eyes (distance between the two pupils) generally falls within the range of 50 mm to 70 mm.

In prior image pickup schemes, a stereoscopic image having a sufficient three-dimensional appearance which is not fatiguing to see can be obtained if the subject of the image is at a near or intermediate distance. However, if the subject is far landscape, it is difficult to achieve three-dimensional appearance.

In the digital camera 100 according to this embodiment, if the subject is at a near or intermediate distance, a stereoscopic image is created from images obtained through the lens module 110, and the created data is sent to the 3D display apparatus without change to allow stereoscopic viewing. On the other hand, if the subject is far landscape, a stereoscopic appearance is created by image processing.

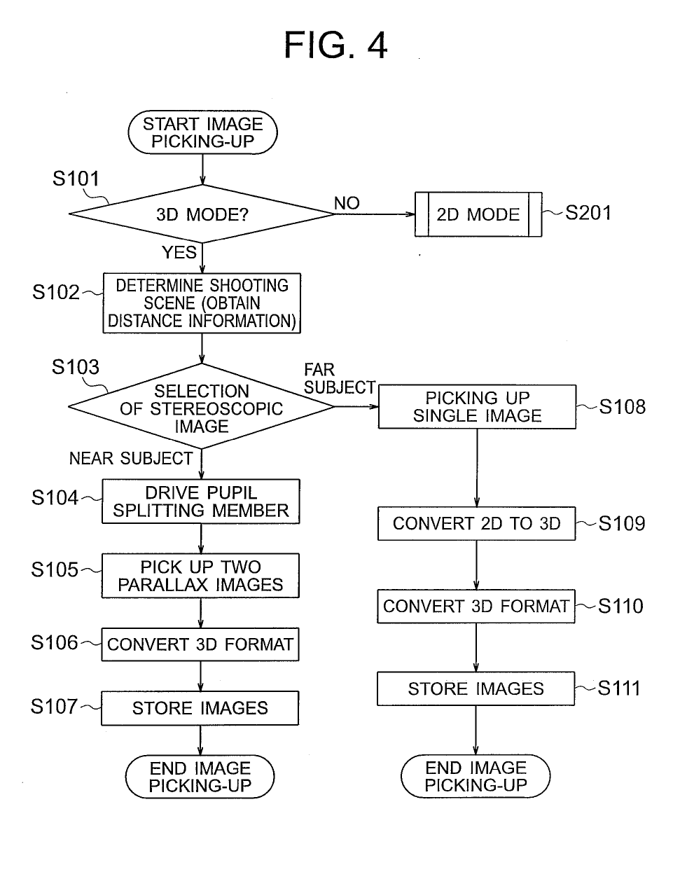

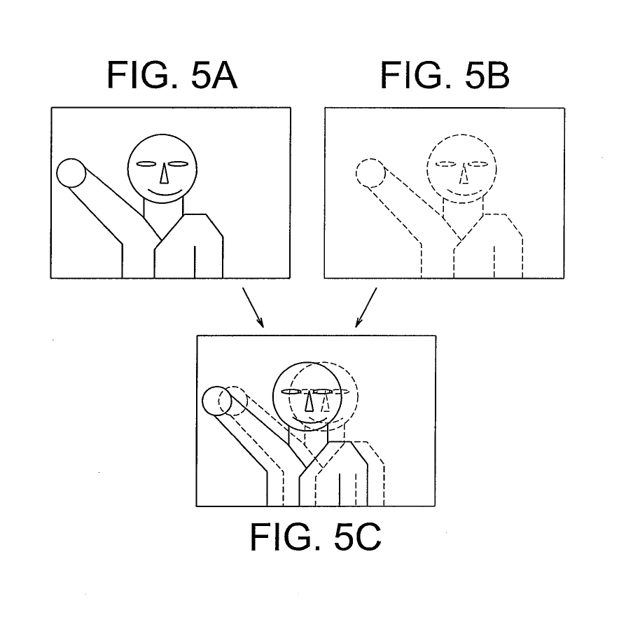

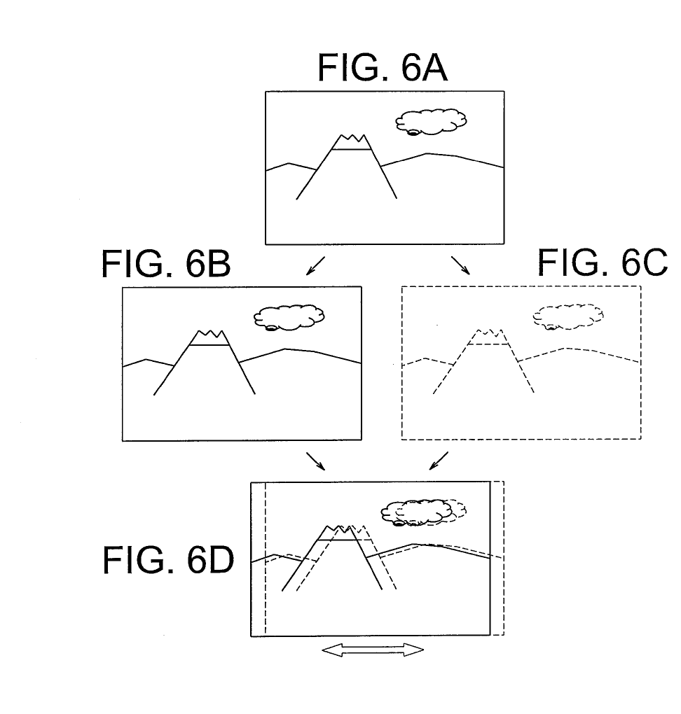

FIG. 4 is a flow chart of the process of creating a stereoscopic image using the digital camera 100. FIGS. 5A, 5B, and 5C schematically illustrate the process of creating a stereoscopic image of a subject at a near distance. FIGS. 6A, 6B, 6C, and 6D schematically illustrate the process of creating a stereoscopic image of a far subject. In FIGS. 5A, 5B, and 5C, FIG. 5A is a right eye image, FIG. 5B is a left eye image, and FIG. 5C is a stereoscopic image created from the images of FIGS. 5A and 5B. In FIGS. 6A, 6B, 6C, and 6D, FIG. 6A is a 2D image, FIGS. 6B and 6C are 2D images identical to the image of FIG. 6A, and FIG. 6D is a stereoscopic image created from the images of FIGS. 6A, 6B, and 6C.

In the digital camera 100, the scene determination section 152 makes a determination as to the shooting scene as described in FIG. 4. If the shooting scene (or shot subject) is a near subject, the storing method determination section 151 obtains two parallax images. On the other hand, if the shooting scene is a far subject (landscape), the storing method determination section 151 obtains a single 2D image, and then the 2D-to-3D converter 141 applies image processing to the 2D image to create a 3D image.

When the image picking-up is started, the system control unit 150 first determines whether or not the 3D mode is set (step S101). Specifically, a determination is made as to whether the 3D mode has been selected by a user through the command unit 145.

If the 3D mode is not set (“NO” in step S101), image picking-up is performed in the 2D mode (step S201). The image picking-up in the 2D mode is the same as conventional image picking-up, and it will not be described further.

On the other hand, if the 3D mode is set (“YES” in step S101), the scene determination section 152 makes a determination as to the shooting scene (step S102). In this process, the scene determination section 152 obtains information on the distance to the subject based on the positions of the first lens 111, the second lens 112, and the third lens 113 and determines whether the subject is a near subject or a far subject.

Then, the storing method determination section 151 selects either the process for far subject or the process for near subject according to the result of determination by the scene determination section 152 (step S103).

If the process for near subject is selected by the storing method determination section 151 (“NEAR SUBJECT” in step S103), the succeeding process (steps S104 to S107) is executed.

Firstly, the pupil splitting member control section 154 drives the pupil splitting member 121 sequentially in such a way as to form images corresponding respectively to the right eye image illustrated in FIG. 5A and the left eye image illustrated in FIG. 5B (step S104). Thus, the image pickup element 120 picks up a right eye image and a left eye image as two parallax images sequentially (step S105).

The two 2D images picked up in step S105 (i.e. the right eye image and the left eye image) are converted by the 3D format converter 142 into 3D format images as a stereoscopic image (second stereoscopic image) (step S106). The 3D format images resulting from the conversion are stored in the recording unit 144 (step S107), and the image picking-up process is ended.

Since there is a parallax between the two images thus stored as will be seen in the right eye image drawn by solid lines and the left eye image drawn by broken lines in FIG. 5C, they allow stereoscopic viewing on an external display apparatus.

On the other hand, when the process for far subject is selected by the storing method determination section 151 (“FAR SUBJECT” in step S103), the subsequent process (steps S108 to S111) is executed.

Firstly, the digital camera 100 picks up a single 2D image without splitting the pupil (step S108). The 2D image thus picked up is converted by the 2D-to-3D converter 141 into a stereoscopic image (first stereoscopic image) (step S109). The image thus converted is further converted by the 3D format converter 142 into a 3D format image (step S110). The 3D format image resulting from this conversion is stored in the recording unit 144 (step S111), and the image picking-up process is ended.

Since the parallax for a far subject is small, two 2D images (FIGS. 6B and 6C) are generated by copying a single 2D image actually picked up (FIG. 6A), and these two 2D images are offset to constitute a paired 3D images (FIG. 6D), which allow stereoscopic viewing.

As described above, in the digital camera 100 according to this embodiment, the process is switched according to the shooting scene. In the case of a near subject, two parallax images obtained through the lens module 110 are directly used to create a stereoscopic image. In the case of a far subject, a 2D image obtained through the lens module 110 is image-processed for stereoscopic image output. Thus, a natural (or inartificial-looking) stereoscopic image of a near subject can be obtained.

In the following, how the determination as to the shooting scene is made will be described.

In determining the shooting scene, the scene mode of the digital camera 100 is used. Digital cameras generally perform scene determination, in which whether the subject is near or far can be determined based on the position of the focus lens. Moreover, the detection of human face can also be provided by the face detection function.

In the determination of the shooting scene in the digital camera 100, the camera-to-subject distance is determined based on the amount of parallax between at least two picked-up images. While the amount of parallax of the two images is large with respect to a near subject, it is small with respect to a far subject. Therefore, in the scene determination, if the amount of parallax is large, it is determined that the subject is near, and if the amount of parallax is small, it is determined that the subject is far.

The image processing in the case where the subject is far (step S109 in FIG. 4) will be described.

### (1) Uniform Image Shift

The 2D-to-3D converter 141 uniformly shifts (or offsets) the single 2D image (FIG. 6A) obtained by image picking-up to the right and left to create two images (FIG. 6B and FIG. 6C) and stores these two images in the recording unit 144. By displaying the two images created by shifting a single image obtained by image picking-up to the right and left, a stereoscopic appearance can be added.

### (2) Parallax Amount Adjustment

The amount of parallax of at least two picked-up images can be determined. If it is determined that the amount of parallax is small, it is preferred that the amount of parallax be increased before storing the images. This enables displaying the images with increased parallax to enhance the stereoscopic effect when they are viewed.

Next, a description will be made of cases where there are both a near subject(s) and a far subject(s).

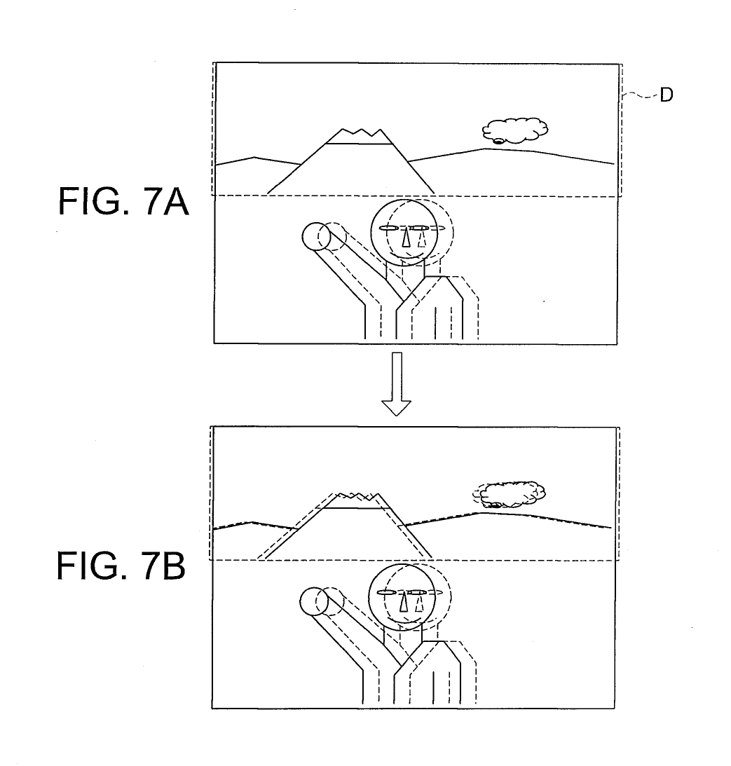

There are shooting scenes in which there are both a near subject(s) and a far subject(s) in addition to scenes in which there is only a near subject(s) (FIGS. 5A, 5B, and 5C) and scenes in which there is only a far subject(s) (FIGS. 6A, 6B, 6C and 6D). Shooting scene determination and image processing in cases where there are both a near subject and a far subject will be described with reference to FIGS. 7A and 7B. FIGS. 7A and 7B schematically illustrate the process of creating a stereoscopic image in a case where there is both a near figure and a far landscape. FIG. 7A is an image to which image processing has not been applied yet, and FIG. 7B is an image to which image processing with respect to the far subject has been applied.

If it is found by the shooting scene determination by the scene determination section 152 that there are both a near subject and a far subject, the scene determination section 152 generates the distribution of the parallax amounts in the image and increases the amount of parallax of the far subject(s) in the obtained image by image processing to enhance the stereoscopic effect. In this process, if the amount of parallax of the obtained parallax images is large, the scene determination section 152 determines that the subject is a near subject, and if the amount of parallax is small, the scene determination section 152 determines that the subject is a far subject.

In cases where there are both a near figure and a far landscape in a scene as shown in FIGS. 7A and 7B, the 2D-to 3D converter 141 executes the process of increasing the amount of parallax of the far landscape (area D) in which the amount of parallax is small. The image processing of increasing the amount of parallax may be performed by creating two images by shifting (or offsetting) the image of the far landscape portion and shifting these images to the right and left in a manner similar to the process in the case where there is only a far subject in the scene.

As described above, the stereoscopic image obtaining apparatus according to the present invention is useful in creating a more natural image.

The stereoscopic image obtaining apparatus according to the present invention can advantageously create a natural stereoscopic image of a near subject.

What is claimed is:

1. A stereoscopic image obtaining apparatus comprising:
an optical system through which at least two parallax images are obtained;
a first image creating unit that creates a first stereoscopic image from a single 2D image;
a second image creating unit that creates a second stereoscopic image from the at least two parallax images; and
a stereoscopic image selection unit that makes a selection between the first image creating unit and the second image creating unit,
wherein the stereoscopic image selection unit makes a selection in such a way that objects for which the first image generation unit is selected are more distant than objects for which the second image generation unit is selected.

2. A stereoscopic image obtaining apparatus according to claim 1, wherein the first image creating unit creates the first stereoscopic image from one 2D image among the at least two parallax images or a 2D image obtained through the optical system.

3. A stereoscopic image obtaining apparatus according to claim 1, wherein at least two parallax images are obtained through the optical system in which the pupil of incident light is split, and the distance between the optical axes of the at least two parallax images is in the range of 1/100 to ⅕ of the distance between human eyes.

4. A stereoscopic image obtaining apparatus according to claim 1, wherein the stereoscopic image selection unit makes a selection based on the amount of parallax of the at least two parallax images.

5. A stereoscopic image obtaining apparatus according to claim 1, wherein the first stereoscopic image created by the first image creating unit and the second stereoscopic image created by the second image creating unit can be mixed.

6. A stereoscopic image obtaining apparatus according to claim 1, further comprising a shooting scene determination unit that estimates the distance to the subject based on the position of a focus lens in the optical system to make a determination as to shooting scene.

7. A stereoscopic image obtaining apparatus according to claim 1, wherein the first image creating unit creates two images by shifting the obtained 2D image to the right and left respectively.

8. A stereoscopic image obtaining apparatus according to claim 1, wherein the at least two obtained parallax images are shifted uniformly to the right and left, and the images thus shifted are stored.

9. A stereoscopic image obtaining apparatus according to claim 1, wherein the apparatus can generate a distribution of the amount of parallax based on the at least two obtained parallax images and control the amount of parallax.
